(19) United States
(12) Patent Application Publication
(10) Pub. No.: US 2005/0246310 A1
(43) Pub. Date: Nov. 3, 2005

(54) File conversion method and system

(76) Inventors: Ching-Chung Chang, Changhua City (TW); Feng-Kuang Sung, Hsinchu City (TW); Cheng-Hui Chiu, Shihtan Township (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/833,915

(22) Filed: Apr. 28, 2004

(51) Int. Cl. G06F 7/00

(52) U.S. Cl. 707/1

(57) ABSTRACT

A computer implemented file conversion method for converting an index file. The index file includes file paths, and each file path corresponds to an actual file. The method first reads the file paths from the index file. If the actual files corresponding to the file paths are files of a first format, the method converts the actual files to files of a second format. Finally, the method designates the file paths of the index file to the converted files.

### BACKGROUND

The present invention relates to a file conversion method and in particular to a file conversion method and system for converting index file for a search engine.

In a Search Engine system, an index file, such as a BIF file (bulk insert file), records descriptions of files stored in various locations of a database or a network. Before a search engine searches and summarizes the files located in different locations, the contents of files must be built and indexed in a dedicated database for the search engine. The descriptions of the files are also recorded in the index file. The index file can be produced automatically by a search engine utility, e.g. a “crawler” (or “spider” named in Verity) tool, or produced by a homemade application program.

For example, if files A, B, and C are stored in different locations, such as web pages, and provided to a search engine for searching and summarizing, the description of files A, B, and C must be recorded in an index file. Three file paths indicating the three original actual files are recorded in the index file. The index file may include other information about the actual files, such as file size or file author. Once the file contents are built and indexed in the dedicated database for the search engine, the index file can be discarded while the indexed file contents and descriptions thereof are stored in the dedicated database.

Thereafter, a keyword is input to the search engine for searching files in the search engine database according to the keyword. Thus, the search engine can summarize the context of the files according to the keyword and the indexed contents. End users are able to view the summaries with highlighted keywords and retrieve the actual files by file paths stored in the search engine.

As mentioned, the file contents must have been previously built and indexed into the search engine before file searching. A common problem is that if the actual files are complex format, such as PDF files, the speed of the search engine will be slow, as the read and comparison with a complex formatted file is time-consuming.

In the conventional method, the index file cannot be modified regardless of the method used to produce the index file. Thus, the described problem of slow search engine speed cannot be improved.

### SUMMARY

Accordingly, an object of the invention is to provide a file conversion method for converting an index file and actual files thereof. The converted index file and its corresponding files can be provided to a search engine for increasing the speed of file searching operations.

To achieve the foregoing and other objects, the invention discloses a computer implemented file conversion method for converting an index file. The index file has file paths and each file path corresponds to a first file. The method first reads the file paths from the index file. If the first files corresponding to the file paths are files of a first format, the method converts the first files to second files of a second format. Finally, the method designates the file paths of the index file as the converted second files. Subsequently, the second files may be built into a database according to the index file. A search engine can search the second files in the database according to a keyword and the index file.

### BRIEF DESCRIPTION OF THE DRAWINGS

The present invention can be more fully understood by reading the following detailed description and examples with references made to the accompanying drawings, wherein:

FIG. 1 is a flowchart of the file conversion method according to one embodiment of the present invention.

FIG. 2 is a diagram of the machine-readable storage medium for storing a computer program providing a file conversion method.

FIG. 3 is a diagram of the file conversion system according to one embodiment of the present invention.

FIG. 4 is a flowchart of the file conversion method according to another embodiment of the present invention.

### DESCRIPTION

As summarized above, the present invention discloses a computer implemented file conversion method for converting an index file. The index file includes file paths and each file path corresponds to a first file. The index file may include other information, such as the IP addresses of the actual files in a network.

First, the file paths are read from the index file. Each file path indicates a first file. Next, the first files are determined if they are first format. If the first files corresponding to the file paths are files with a first format, such as PDF, the first files are converted to second files of a second format, such as TXT. Finally, the file paths in the index file are designated as the second files. Thus, a search engine can connect to the second files according to the file paths recorded in the index file.

During the file conversion process, a label may be attached to a second file after file conversion for indicating that the file has been converted. The label can be used to verify the file conversion status, thereby preventing redundant file conversion.

Subsequently, the second files are built into the database according to the index file. A search engine can search the first file by the second file content and attributes built in the database.

Thus, a file conversion method is provided to increase search speed. In a database, files are converted to simple format files for a search engine. The file paths are recorded for the search engine in an index file. The search engine can search the converted files according to keywords and display a search result, such as summaries of the converted files with highlighted keywords.

Moreover, a machine-readable storage medium for storing a computer program providing a file conversion method for converting an index file is disclosed. The index file has file paths and each file path corresponds to a first file. The method comprises the mentioned steps.

Furthermore, a file conversion system for converting an index file is disclosed. The index file includes file paths indicating first files. The disclosed system includes a file reader, a file converter, and a file designator.

The file reader reads the file paths from the index file. The file converter converts the first files to second files of a second format if the first files corresponding to the file paths are of a first format. The file converter further attaches a label to the second file after conversion to represent the conversion status of the second file. Thus, before conversion, the label can be checked to verify the conversion status of the files.

The file designator designates the file paths of the index file as converted second files. The file designator further builds the converted second files into a search engine database according to the index file. The disclosed system may comprise a search engine. The search engine obtains a keyword and searches the second files in the database according to the keyword and the index file. Here, again, the mentioned first format may be a complex file format, such as PDF, while the second format may be a simple format, such as TXT.

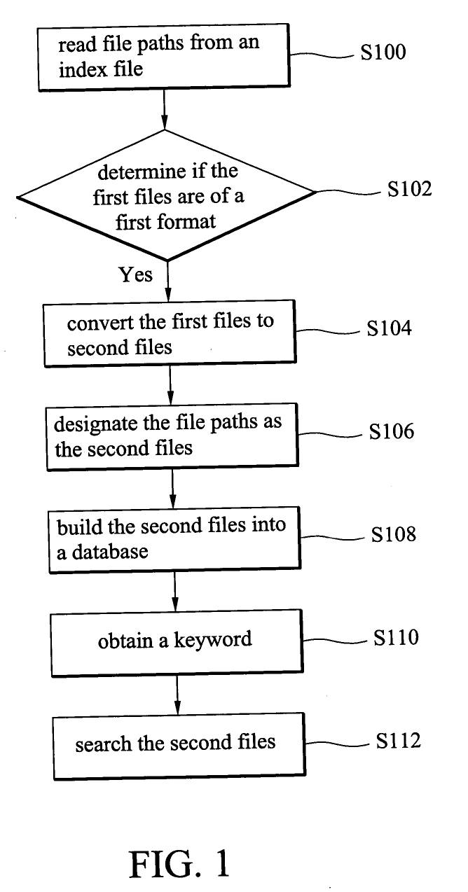

FIG. 1 is a flowchart of the file conversion method according to one embodiment of the present invention. In one embodiment, the file paths are first read from an index file (step S100). Each file path indicates a first file.

Next, if the first files corresponding to the file paths are files of a first format (step S102), the first files are converted to second files of a second format (step S104). That is, the first files indicated by the file paths, such as PDF files, are converted to files of a second format, such as TXT files.

The file paths in the index file are then designated as the converted second files (step S106). It is noted that other information recorded in the index file may be unchanged, such as the IP addresses of the actual files, for further operations.

Subsequently, the second files are built into the search engine database according to the index file (step S108). A search engine may be utilized to obtain a keyword (step S110) and the search engine searches the second files according to the keyword and the index file (step S112).

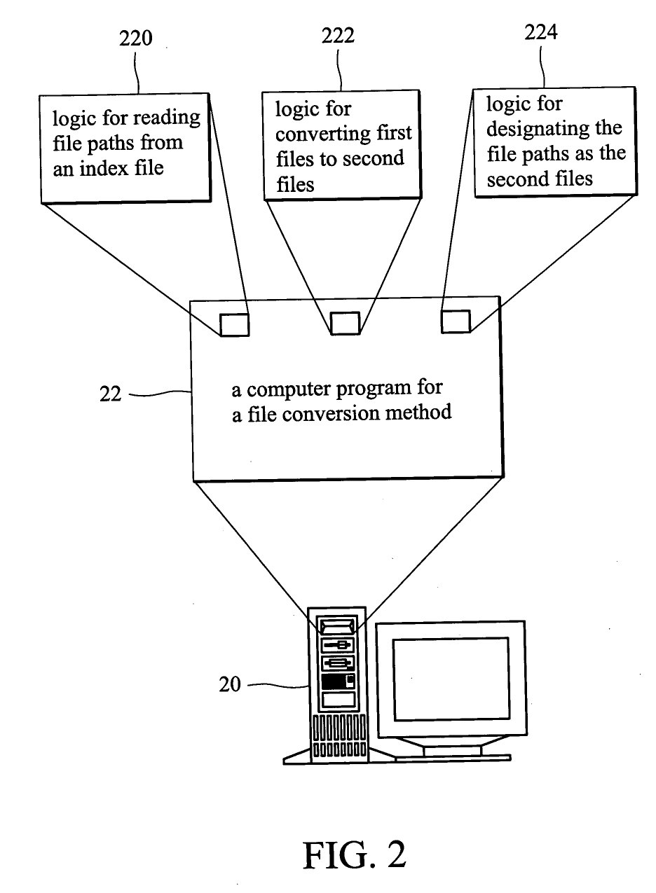

FIG. 2 is a diagram of the machine-readable storage medium for storing a computer program providing a file conversion method. In one embodiment, a machine-readable storage medium 20 for storing a computer program 22 providing a file conversion method for converting an index file is disclosed. The index file has file paths corresponding to first files. The computer program 22 mainly comprises logic for reading the file paths from the index file 220, logic for converting the first files to second files 222, and logic for designating the file paths as the converted second files 224.

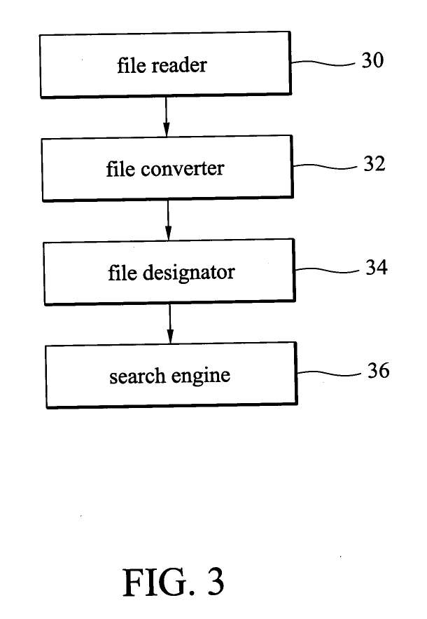

FIG. 3 is a diagram of the file conversion system according to one embodiment of the present invention. In one embodiment, a file conversion system for converting an index file is disclosed. The index file includes file paths indicating first files. The file conversion system comprises a file reader 30, a file converter 32, a file designator 34, and a search engine 36.

The file reader 30 reads the file paths from the index file. The file converter 32 converts the first files to second files of a second format if the first files corresponding to the file paths are files of a first format.

A label is utilized for verification of file conversion status. Prior to file conversion, the file converter 32 first verifies if a label exists to ensure that the first file is not converted. Subsequent to file conversion, the file converter 32 attaches a label to the converted second file indicating the converted status thereof, thus preventing redundant file conversion.

The file designator 34 designates the file paths in the index file as the converted second files. The file designator 34 further builds the second files into a database according to the index file. The search engine 36 obtains a keyword and searches the second files in the database according to the keyword and the index file.

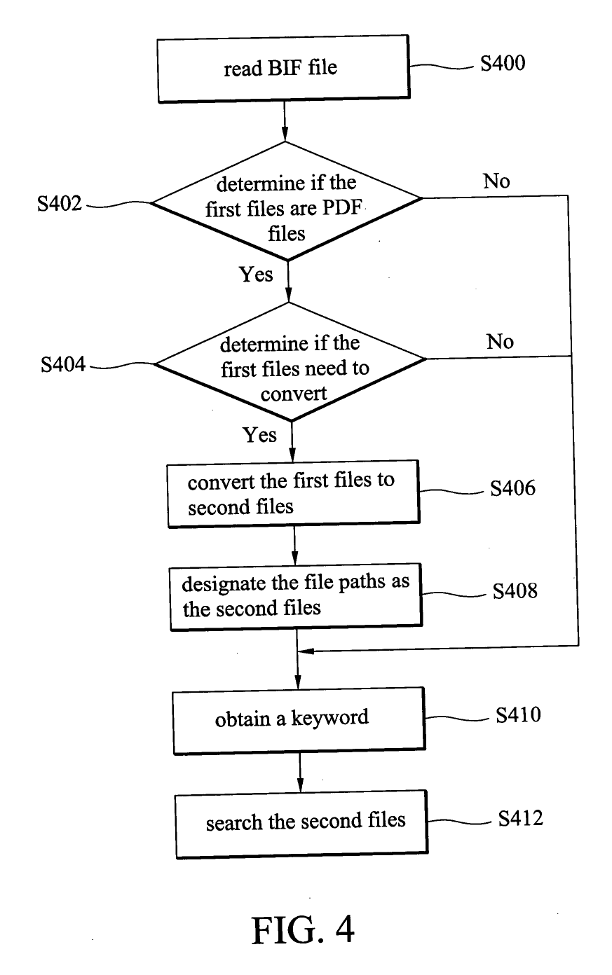

FIG. 4 is a flowchart of the file conversion system according to another embodiment of the present invention. In another embodiment, the index file is a BIF file, the first format is PDF, and the second format is TXT. The BIF file includes file paths to first files. For example, for an IC (integrated circuit) product manufacturer, a database is utilized to store files for a search engine, such as IC product related data. A search engine is used to search the database.

The file paths are first read from a BIF file (step S400). Each file path is a link to a first file. Next, if the first files corresponding to the file paths are PDF files (step S402), the system verifies if the first files have already been converted (step S404). If the first files require conversion, the first files are then converted to second files of TXT format (step S406).

Conversion status is verified by determining whether or not a label exists. A label may be attached to a second file after file conversion for verification, thus, preventing redundant file conversion. The file paths are designated accordingly to the second files (step S408) while other information in the index file remains unchanged.

In step S402, if the first files are not PDF files, the first files will not be converted. Additionally, in step S404, if the first files are verified as converted, the first files will not be converted. If the first files do not require conversion, the method proceeds to step S410, i.e. the database is searched by a search engine.

Finally, the second files are stored in the database according to the index file. Subsequently, a search engine obtains a keyword (step S410). The keyword can be input by a network user through user interface. The search engine then searches the second files in the database according to the keyword and the index file (step S412).

The search result can be displayed as summaries of the second files with the highlighted keyword. If connection to the actual files is desired, the unchanged information recorded in the index file is provided for other data operations.

Thus, a file conversion method is provided to improve search engine speed. The disclosed method converts the files of a complex format to files of a simple format and provides the converted files to a search engine for data searching. The inventive method represents significant improvement for databases with a large number of files with complex formatting.

It will be appreciated from the foregoing description that the method and system described herein provide a dynamic and robust solution to the problem of slow search engine speed. If, for example, the format of the actual files or the index file is altered, the method and system of the present invention can adjust accordingly.

The method and system of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over a transmission medium, such as electrical wire, cable, fiberoptics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A computer implemented file conversion method, wherein an index file has at least one file path and each file path corresponds to a first file, comprising the steps of:
reading the file path from the index file;
determining if the first file corresponding to the file path is first format;
converting the first file to a second file of a second format if the first file is the first format; and
designating the file path of the index file as the second file.

2. The computer implemented file conversion method of claim 1, further comprising building the second file into a database according to the index file.

3. The computer implemented file conversion method of claim 2, further comprising the steps of:
obtaining a keyword by a search engine; and
searching the second file in the database according to the keyword and the index file using the search engine.

4. The computer implemented file conversion method of claim 1, wherein a label representing conversion status is attached to the second file after file conversion.

5. The computer implemented file conversion method of claim 1, wherein a label representing conversion status is verified in the first file before file conversion.

6. The computer implemented file conversion method of claim 1, wherein the first format is portable document format (PDF).

7. The computer implemented file conversion method of claim 1, wherein the second format is text format (TXT).

8. A machine-readable storage medium for storing a computer program providing a file conversion method, wherein an index file has at least one file path and each file path corresponds to a first file, the method comprising the steps of:
reading the file path from the index file;
determining if the first file corresponding to the file path is first format;
converting the first file to a second file of a second format if the first file is first format; and
designating the file path of the index file as the second file.

9. The machine-readable storage medium of claim 8, further comprising building the second file into a database according to the index file.

10. The machine-readable storage medium of claim 9, further comprising the steps of:
obtaining a keyword by a search engine; and
searching the second file in the database according to the keyword and the index file using the search engine.

11. The machine-readable storage medium of claim 8, wherein a label representing conversion status is attached to the second file after file conversion.

12. The machine-readable storage medium of claim 8, wherein a label representing conversion status is verified in the first file before file conversion.

13. The machine-readable storage medium of claim 8, wherein the first format is portable document format (PDF).

14. The machine-readable storage medium of claim 8, wherein the second format is text format (TXT).

15. A file conversion system, wherein an index file has at least one file path and each file path corresponds to a first file, comprising:
a file reader, reading the file path from the index file;
a file converter, coupled to the file reader, converting the first file to a second file of a second format if the first file is first format; and
a file designator, coupled to the file converter, designating the file path of the index file as the second file.

16. The file conversion system of claim 15, wherein the file designator further builds the second file into a database according to the index file.

17. The file conversion system of claim 16, further comprising a search engine, wherein the search engine obtains a keyword and searches the second file in the database according to the keyword and the index file.

18. The file conversion system of claim 15, wherein the file converter further attaches a label representing conversion status to the second file after file conversion.

19. The file conversion system of claim 15, wherein the file converter further verifies a label representing conversion status in the first file before file conversion.

20. The file conversion system of claim 15, wherein the first format is portable document format (PDF).

21. The file conversion system of claim 15, wherein the second format is text format (TXT).
